(19) United States
(12) Patent Application Publication
(10) Pub. No.: US 2009/0241353 A1
(43) Pub. Date: Oct. 1, 2009

(54) Toolless Apparatus for Guide Bar for Chain Saw

(76) Inventors: Scott William Ericson, Anderson, SC (US); Rodney Harms, Anderson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/060,684

(22) Filed: Apr. 1, 2008

(51) Int. Cl. B27B 17/02

(52) U.S. Cl. 30/386

(57) ABSTRACT

A chain saw is provided in which the tension of a cutting chain extending along a periphery of the guide bar may be adjusted without use of a tool. A locking knob is provided which engages with a cover of the chain saw. Protrusions of the locking knob fit within corresponding notches of the cover. The shape of the protrusions and the notches allow rotation of the locking knob in a first direction but not a second direction. Upon disengaging the locking knob from the cover, the guide bar may move relative to the engine housing and clutch cover to tighten the cutting chain extending along a periphery of the guide bar.

### TECHNICAL FIELD

The present invention relates to a locking mechanism for the guide bar of a chain saw.

### BACKGROUND

Proper operation of a cutting chain of a chain saw requires that the links of the cutting chain be securely seated within a channel or groove extending along the periphery of a guide bar of the chain saw. Continual use of a cutting chain of a chain saw may cause the chain to loosen along the periphery of an elongated plate or guide bar. Such loosening of the chain causes slack in the chain. Removal of the slack may be achieved by moving the guide bar longitudinally with respect to the engine housing and cover such that the cutting chain is tightened about the periphery of the guide bar.

Conventional chain saws may require an operator to use one or more tools to loosen the guide bar disposed between the engine housing and the cover so that the guide bar can move to cause tightening of the cutting chain along the guide bar. Additionally, such saws require tools to secure the guide bar in its new position. The use of one or more tools may increase downtime of the chain saw and require intensive labor.

Conventional chain saws may also be prone to inadvertent slippage of the guide bar during operation of the chain saw if the guide bar fails to remain secured between the engine housing and the cover. It would be desirable to provide a chain saw in which the guide bar can be quickly and reliably moved in the longitudinal direction to tighten a cutting chain extending along the periphery of the guide bar and thereafter secured in its new position.

### SUMMARY

In a first aspect of the invention, a chain saw is provided. The chain saw comprises a housing supporting an engine, a cover selectively secured to the housing, a cutting chain, a locking mechanism, and an adjustment mechanism. The cover includes a plurality of notches. Each of the plurality of notches is defined by a first notch edge inclined in a first direction and a second notch edge opposite the first edge and substantially perpendicular to a flat surface of the cover. The cutting chain extends along a periphery of a guide bar located between the housing and the cover. The locking knob includes a plurality of protrusions adapted to fit within the notches. Each of the plurality of protrusions includes a first protrusion edge inclined in a direction opposite the first notch edge and a second protrusion edge substantially perpendicular to a flat surface of the knob. The second protrusion edge abuts against the second edge to define a locked position to secure the guide bar from movement with respect to the housing and the cover. The protrusions of the knob are configured to disengage from within the plurality of notches to allow the guide bar to move with respect to the housing and the cover.

In a second aspect of the invention, a chain saw is provided. The chain saw includes a housing supporting an engine, a cover selectively secured to the housing and including a plurality of notches, a cutting chain extending along a periphery of a guide bar located between the housing and the cover, and a locking knob comprising a plurality of tooth-like protrusions configured to removably engage with the notches of the cover in a one-way ratcheted arrangement so as to secure the guide bar from relative movement with respect to the cover and housing. Each of the plurality of notches of the cover is defined by a first notch edge inclined in a first direction and a second notch edge opposite the first edge and substantially perpendicular to a flat surface of the cover. The plurality of tooth-like protrusions of the knob are configured to disengage from the plurality of notches of the cover to allow an intermeshed gear assembly to move the guide bar with respect to the housing and the cover without any tools.

### BRIEF DESCRIPTION OF THE DRAWINGS

Embodiments will now be described by way of example with reference to the accompanying drawings.

FIG. 1 is a perspective view of a chain saw incorporating the features of the present invention.

FIG. 2 is side perspective view of the locking knob.

FIG. 3 is a perspective view of a portion of the cover shown with the other portions not shown to increase clarity.

FIG. 4 is a rear view of an intermeshed gear assembly coupled to a bar adjustment pin for moving the guide bar.

FIG. 5 is a rear perspective of the locking knob engaged with the cover.

FIG. 6 is a perspective view of the engine housing.

### DETAILED DESCRIPTION

The embodiments are described with reference to the drawings in which like elements are referred to by like numerals. The relationship and functioning of the various elements of the embodiments are better understood by the following detailed description. However, the embodiments as described below are by way of example only, and the invention is not limited to the embodiments illustrated in the drawings. It should also be understood that the drawings are not to scale and in certain instances details have been omitted, which are not necessary for an understanding of the embodiments, such as conventional details of fabrication and assembly.

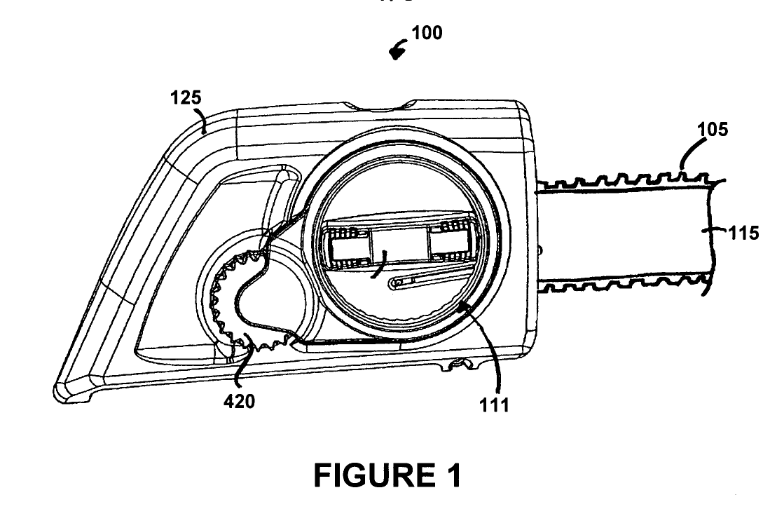

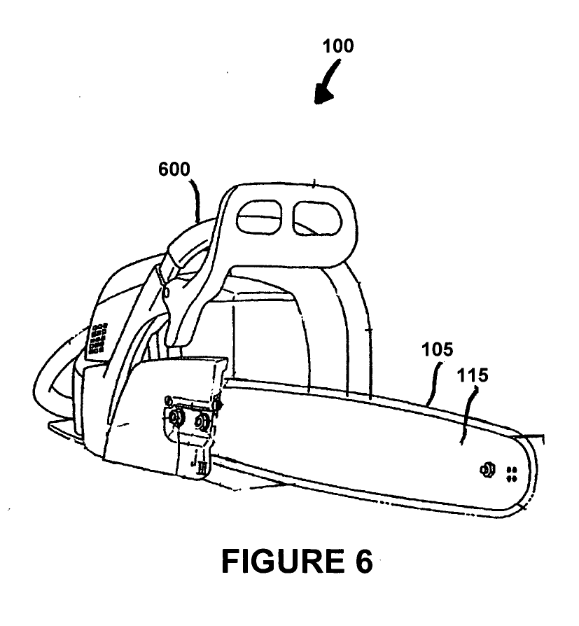

FIG. 1 shows a chain saw 100 incorporating the locking mechanism 111 of the present invention. The chain saw 100 includes an engine (not shown) at least partially located in a housing 600. A cutting chain 105 extends along a periphery of a guide bar 115 located between the housing 600 (FIG. 6) and the cover 125. The guide bar 115 is an elongated plate with at least one groove around its periphery into which the cutting chain 105 rides. A rear portion of the guide bar 115 is disposed between the engine housing 600 and the cover 125.

The cover 125 includes a locking mechanism 111 that includes a locking knob 110 that is rotatable between a locked configuration and an unlocked configuration. FIG. 1 shows the locking knob 110 in the locked configuration. Generally speaking, rotating the locking knob 110 from the locked to the unlocked configuration allows the guide bar 115 to move with respect to the housing 600 and the cover 125 so that the cutting chain 105 can be tightened around the guide bar 115.

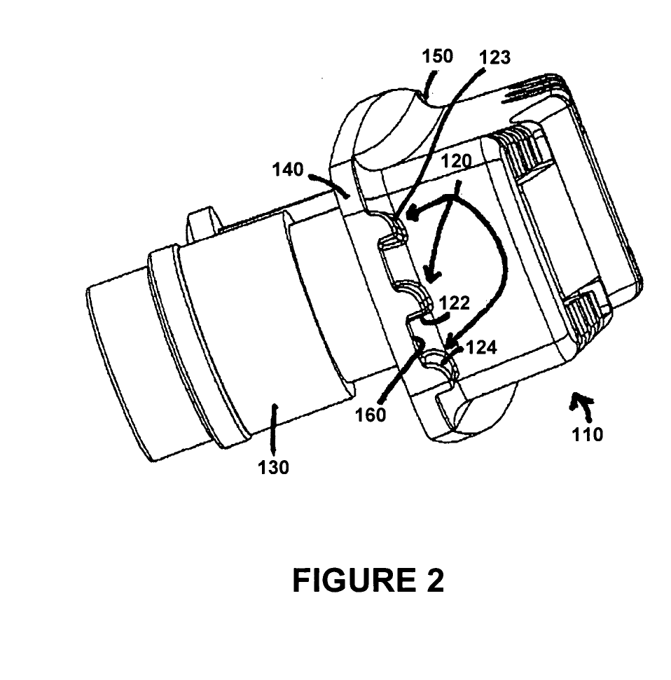

Engagement of the locking knob 110 with the cover 125 secures the guide bar 115 in a fixed position between the engine housing 600 and the cover 125. The cover 125 is operatively connected to the engine housing 600 by a knob insert 130, as shown in FIG. 2. The knob insert 130 attaches to a bar stud of the guide bar 115 to secure the guide bar 115 to the chain saw 100. Rotating the locking knob 110 from the unlocked to the locked configuration causes the knob insert 130 to move from a loosened position to a tightened position. When the knob insert 130 is in the tightened position, the cover 125 is pressed toward the guide bar 115 and the engine housing 600, thereby securing the guide bar 115 between the engine housing 600 and the cover 125.

Disengagement of the locking knob 110 with the cover 125 allows the guide bar 115 to move relative to the engine housing 600 and the cover 125. In particular, rotating the locking knob 110 from the locked to the unlocked configuration causes the knob insert 130 to move from a tightened to a loosened position. When the knob insert 130 is in the loosened position, the cover 100 is released away from the guide bar 115 to allow the guide bar 115 to move relative to the engine housing 600 and the cover 125.

In one embodiment, the locking knob 110 includes a one-way ratchet mechanism. Turning to FIG. 2, the locking knob 110 comprises a plurality of protrusions 120 extending along edges 140 and 150 of the knob 110. It is also contemplated that the protrusions 120 may be provided on only one of the edges 140 and 150. Each of the protrusions 120 has a first protrusion edge 121 inclined, as shown in FIG. 2. The first protrusion edge 121 may be inclined at any appropriate angle from the vertical (i.e., angled from a plane perpendicular to a flat surface 160 of the knob 110). Rather than being inclined, the first edge 121 may be convexly curved. Each protrusion 120 also has a second protrusion edge 122. The second protrusion edge 122 is shown in FIG. 2 to be substantially perpendicular to a flat surface 160 of the knob 110. The distal end 123 of the edge 121 may be rounded to facilitate one-way tightening as will become clear from the description below.

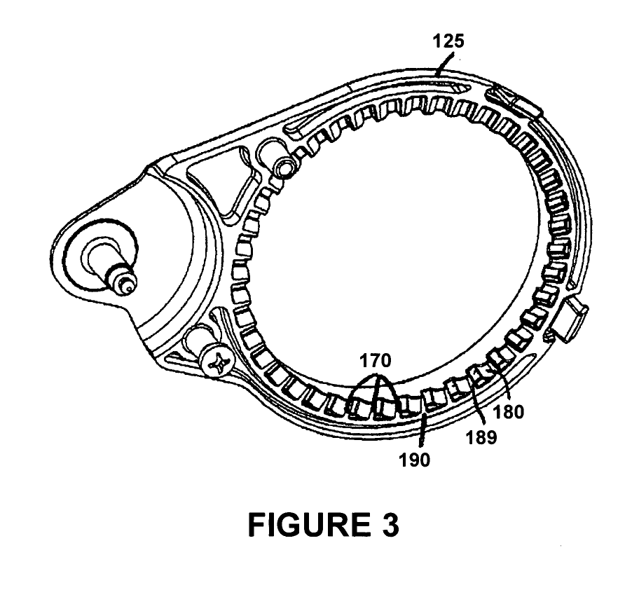

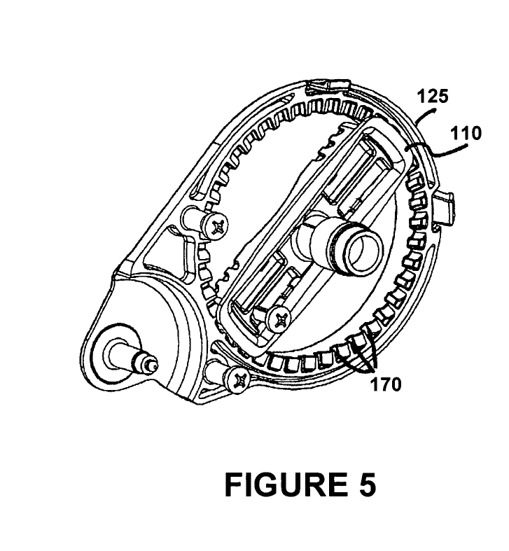

The first and second protrusion edges 121 and 122 of the locking knob 110 are adapted to fit within a plurality of notches 170 of the cover 125, as best seen in FIG. 5. FIG. 3 shows a portion of the rear of the cover 125. A plurality of notches 170 extend circumferentially about the periphery of an opening provided in the cover 125. Each of the plurality of notches 170 has a first notch edge 180 and a second notch edge 185. The first notch edge 180 is inclined in a first direction at a predetermined angle. As with the first protrusion edge 121, the first notch edge 180 may be inclined at any angle from the vertical (i.e., angled from a plane perpendicular to a peripheral edge 190 of the cover). In one embodiment, the inclination of the first protrusion edge 121 is about the same as the inclination of the first notch edge 180 so that one may slide over the other when in contact and the knob 110 is rotated with respect to the cover 125. The second notch edge 185 is oriented opposite the first notch edge 180. In this regard, when the first protrusion edge 121 is convexly curved, the first notch edge 180 will likewise be convexly curved. The second notch edge 185 is also shown oriented substantially perpendicular to a peripheral edge 190 (FIG. 3) of the cover 125.

When the knob 110 is in the locked position, each of the protrusions 120 of the knob 110 mate with a corresponding notch 170 of the cover 125 (FIG. 5). The second protrusion edge 122 abuts the second notch edge 185 to define a locked position. It will be understood that because each of the second protrusion edge 122 and second notch edge 185 are parallel to each other and because the edges 122 and 185 abut (desirably along a parallel line, i.e., they about along more than a point), the knob 110 will not rotate (or loosen) with respect to the cover 125. Thus, the guide bar 115 will be securely held in a selected position even during use.

Disengagement of the protrusions 120 from the notches 170 is achieved by pushing the knob 110 inwards towards the cover 125 and engine housing 600. In one embodiment, the biasing structure of the knob 110 is a spring. It is to be appreciated that any biasing structure for the knob 110 is contemplated. Pushing on the knob 130 causes the spring to compress so that the knob 110 is pushed inwards and away from the user. The knob 110 is pushed inwards a sufficient amount to enable the protrusions 120 of the knob 110 to disengage from the notches 170 of the cover 125. This disengagement allows the knob 110 to be rotated with respect to the cover 125. When the protrusions 120 of the knob 110 are disengaged from the notches 170 of the cover 125, the adjustment mechanism can be actuated to move the guide bar 115 with respect to the cover 125 and engine housing 600. The adjustment mechanism includes the knob 110 which can be rotated in a loosening direction so that the cover 125 can be moved away from the engine housing 600 to allow the guide bar 115 to move with respect to the cover 125 and engine housing 600. Rotation of the knob 110 in a loosening direction is continued until the guide bar 115 can be moved.

After the guide bar 115 is moved to the selected desired position, the knob 110 can be rotated in an opposite, tightening position. It will be appreciated that the knob 110 can be rotated in a tightening direction to lock the guide bar 115 in the selected desired position because of the inclination of the edges 121 and 180. As the knob 110 is rotated, the first protrusion edge 121 can rotatably slide upwardly pass the incline of first notch edge 180 of the cover 125. Because the incline of the first protrusion edge 121 and the incline of the first notch edge 180 are opposite, selective rotation in one tightening direction. The orientation of the second protrusion edge 122 with the second notch edge 185 of the cover 125 enables one-way ratcheted movement in a first rotational tightening direction in which the first protrusion edge 121 rotatably slides pass the first notch edge 180 of successive notches 170. As noted above, the second protrusion edge 122 is not able to slide pass successive second notch edges 185 of the cover 125 in a second rotational direction opposite to the first rotational direction because of the abutment (i.e., desirably along a line) between the second protrusion edge 122 and the second notch edge 185, thereby avoiding inadvertent loosening of the knob 110. Accordingly, the cover 125 is secured to the engine housing 600 and the guide bar 115 is locked in a selected position.

It is to be further appreciated that the locking arrangement between the knob 110 and the cover 125 may be modified. For example, the notches 170 of the cover 125 need not extend completely circumferentially about the periphery of the cover 125. Alternatively, the protrusions 120 may be disposed along the cover 125 and the notches 170 disposed along the knob 110.

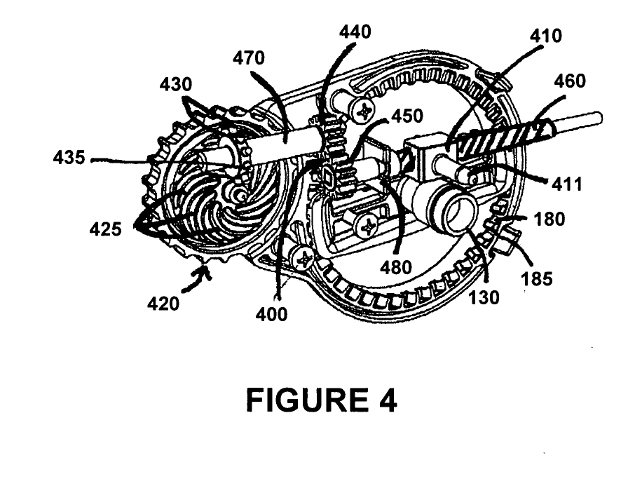

Movement of the guide bar 115 when the knob 110 is in an unlocked configuration will now be discussed with reference to FIG. 4. When the knob 110 is unlocked, the guide bar 115 can be moved and the tension of the cutting chain 105 can be changed. The portion of the cover 125 adjacent the engine housing 600 is configured to locationally position various components of the adjustment mechanism. The adjustment mechanism comprises intermeshed gears 400 to cause movement of the guide bar 115 via movement of a bar adjust pin 410. An opening is provided in the guide bar 115 and it receives a finger 411 extending from the bar adjust pin 410 such that the finger 411 is secured within the guide bar opening 115. The bar adjust pin 410 is internally threaded to threadably mate with an externally threaded shaft 460.

FIGS. 1 and 4 show an adjustment dial 420. In operation, rotation of the adjustment dial 420 causes the externally threaded elongate member 460 to rotate through the intermeshed gears 400 which causes the bar adjustment pin 410 to travel along the longitudinal length of the elongate member 460. Because the finger 411 is engaged with the guide bar 115, as the bar adjustment pin 410 moves, the guide bar 115 moves.

The adjustment dial 420 has swirled meshed grooves 425 that receive spokes 430 of a wheel 435. The wheel 435 is affixed to one end of a shaft 470. The other end of the shaft 470 has a first intermeshed gear 440. The first intermeshed gear 440 is engaged with a second intermeshed gear 450 which is fixed to one end of the elongate member 460. The other end of the elongate member 460 is rotatably received within an opening of the cover 125 so that the elongate member 460 remains aligned. A collar 480 fitted within a slot in the cover 125 rotatably receives a portion of the elongate member 460 near gear 450 so that elongate member 460 will be axially fixed with respect to the cover 125. In addition, the collar 480 helps to maintain the first and second gears 440 and 450 in a meshed engagement. Although an intermeshed gear mechanism 400 has been described, other means for urging the guide bar 115 are contemplated and would be appreciated by one of ordinary skill in the art.

Once adjustment is accomplished, the locking knob 110 can be rotated in a tightening direction to secure the guide bar 115 in its new longitudinal position. Re-engagement is achieved by the user releasing the knob 110 so that the spring-like structure of the knob 110 returns to its uncompressed configuration towards the user. This causes the protrusions 170 of the locking knob 110 to mate within the notches 170 of the cover 125 to define a locked configuration. Thus, the guide bar 115 can be secured in its new position without the use of any tools.

Operation of the chain saw 100 is advantageous as compared to conventional chain saws because a user may adjust the tension of the cutting chain 105 from the exterior of the chain saw 100. There is no need to remove any parts when a user manually rotates the manual adjust dial 420 to loosen the guide bar 115 from the engine housing 600 and cover 125. The manual adjust dial 420 is rotated by hand without the use of any tools. There is also no need to use any tools to secure the guide bar 115 in its new longitudinal position.

The above figures and disclosure are intended to be illustrative and not exhaustive. This description will suggest many variations and alternatives to one of ordinary skill in the art. All such variations and alternatives are intended to be encompassed within the scope of the attached claims. Those familiar with the art may recognize other equivalents to the specific embodiments described herein which equivalents are also intended to be encompassed by the attached claims.

1. A chain saw comprising:
a housing supporting an engine;
a cover selectively secured to the housing and including a plurality of notches, each of the plurality of notches defined by a first notch edge inclined in a first direction and a second notch edge opposite the first edge and substantially perpendicular to a flat surface of the cover;
a cutting chain extending along a periphery of a guide bar that is located between the housing and the cover; and
a locking knob including a plurality of protrusions adapted to fit within the notches, each of the plurality of protrusions comprising a first protrusion edge inclined in a direction opposite the first notch edge and a second protrusion edge substantially perpendicular to a flat surface of the knob, the second protrusion edge abutted against the second edge to define a locked position to secure the guide bar from movement with respect to the housing and the cover;
wherein the protrusions of the knob are configured to disengage from within the plurality of notches to allow the guide bar to move with respect to the housing and the cover.

2. The saw of claim 1, wherein the first protrusion edge is convexly curved.

3. The saw of claim 1, wherein the first notch edge is convexly curved.

4. The saw of claim 1, wherein in the locked position the first protrusion edge is oriented adjacent to the first notch edge.

5. The saw of claim 1, wherein the knob is further configured to be moved toward the housing.

6. The saw of claim 1, wherein the knob is rotatable about a central axis of the clutch cover in a first direction.

7. The saw of claim 6, wherein in the first direction the first protrusion edge is movable over the first notch edge.

8. The saw of claim 1, wherein the knob is locked from rotating about a central axis of the clutch cover in a second direction opposite to the first direction.

9. The saw of claim 8, wherein in the second direction the second protrusion edge abuts the second edge.

10. A chain saw comprising:
a housing supporting an engine;
a cover selectively secured to the housing and including a plurality of notches, each of the plurality of notches defined by a first notch edge inclined in a first direction and a second notch edge opposite the first edge and substantially perpendicular to a flat surface of the cover;
a cutting chain extending along a periphery of a guide bar located between the housing and the cover; and
a locking knob comprising a plurality of tooth-like protrusions configured to removably engage with the notches of the cover in a one-way ratcheted arrangement so as to secure the cover against the guide bar;
wherein the plurality of tooth-like protrusions of the knob are configured to disengage from the plurality of notches of the cover to allow the guide bar to move with respect to the housing and the cover.

11. The saw of claim 10, wherein the tooth-like protrusions are sloped at a predetermined angle

12. The saw of claim 10, wherein the knob is further configured to be moved toward the housing.

13. The saw of claim 10 further comprising a gear assembly coupled with the guide bar to move the guide bar.

14. The saw of claim 13, wherein the gear assembly further comprises a first gear configured in a meshed engagement with a second gear.

15. The saw of claim 14, wherein the first gear is mounted on a shaft and the second gear is mounted on an externally threaded elongate member.

16. The saw of claim 15, further comprising an adjustment dial that includes grooves configured to rotatably engage with a wheel coaxially mounted on the shaft.

17. The saw of claim 15, wherein a bar adjustment pin is threadably connected to the elongate member.

18. The saw of claim 17, wherein the bar adjustment pin further comprises a portion that slidably fits within a slot of the guide bar.

19. A chain saw comprising:
a housing supporting an engine;
a cover selectively secured to the housing and including a plurality of notches, each of the plurality of notches defined by a first notch edge inclined in a first direction and a second notch edge opposite the first edge and substantially perpendicular to a flat surface of the cover;
a cutting chain extending along a periphery of a guide bar located between the housing and the cover;
a gear assembly coupled with the guide bar to move the guide bar; and
a locking knob comprising a plurality of tooth-like protrusions configured to removably engage with the notches of the cover in a one-way ratcheted arrangement so as to secure the guide bar from relative movement with respect to the cover and the housing;
wherein the plurality of tooth-like protrusions of the knob are configured to disengage from the plurality of notches of the cover to allow the guide bar to move with respect to the housing and the cover without any tools.

20. The chain saw of claim 19, wherein the intermeshed gear assembly further comprises a first gear mounted on a shaft and a second gear mounted on an externally threaded elongate member, the first gear being in a meshed engagement with the second gear.
